(19) United States
(12) Patent Application Publication
(10) Pub. No.: US 2006/0242248 A1
(43) Pub. Date: Oct. 26, 2006

(54) Shortcut generator for services accessible via a messaging service system

(76) Inventor: Heikki Kokkinen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/112,838

(22) Filed: Apr. 22, 2005

(51) Int. Cl. G06F 15/16

(52) U.S. Cl. 709/206

(57) ABSTRACT

A method and equipment by which a mobile station (10) is able to request a service of a content provider (23) via a message center (22) (or other server of a communication network) without having to key in an identifier for the service (among other things). The invention includes a shortcut generator (24a) for providing a user interface application (10c) created or configured—via a configuration file (10d)—to correspond to services selected by a user from a list of services. The user interface application (10d), possibly in combination with the configuration file (10d), provides respective executable shortcuts to the services selected by the user from the list of services. The shortcut are downloaded or other transferred to the mobile station (10), and used in requesting, from time to time, the corresponding services.

### TECHNICAL FIELD

The present invention pertains to the field of providing services via a communication network, and more particularly, to enhancing the use of services of a content provider providing content/services via the communication network to a communication device (such as a mobile phone).

### BACKGROUND ART

Cellular communication networks today are often implemented (by a network operator) so as to include messaging service systems, such as the so-called short message service (SMS) or the multimedia message service (MMS). Such messaging services convey messages between mobile stations/cell phones or other communication devices able to access the cellular communication system. SMS, which is often available on digital GSM networks, typically allows text messages of up to 160 characters to be sent and received via the mobile network's SMS Center. If the phone is powered off or out of range, messages are stored in the SMS Center and are delivered at the next opportunity. MMS is an extension of the services offered by SMS: it allows a subscriber to send or receive not only text, but also multimedia content such as images, audio, text, video and combinations of such content.

Initial applications of SMS focused on plain messaging between mobile phone users and sending voice mail notification. As technology and networks evolved, the usage of SMS has exploited to drive a variety of services. Nowadays, SMS is used to send and receive e-mail, fax, and web-based messaging services. Another popular use of SMS is to query information services such as stock quote, weather report. In this case, a content provider of such information receives specialized text queries sent by the user using SMS, processes the query, and returns the result or requested information to the user's mobile phone using SMS.

When a user wants to utilize or request such a service, the user will typically input a number identifying the destination service, e.g. a SMS number, in order to reach the wanted service. Further a user also includes in the message content some identifier in order to identify a chosen service and typically also any values of parameters of the service in order to specify the service request or limit the requested result to certain areas, objects, time periods, etc. For example, a content provider might offer weather reports via a messaging service. Then a subscriber specifies e.g. in a text message (SMS) that a weather report is wanted, e.g. by writing “weather” at the beginning of the message. This indication of e.g. “weather” is pre-determined by the content provider, and text messages sent to the number for the content provider starting with the indication are identified based on the indication, and thus handled by the service provider as a request for a weather report. If more specific weather information is desired, for example a weather report for South Finland, a parameter value of “South Finland” can be added to a message after the service identification. It is common to have optional parameters, which can be included to more particularly specify a service. Typically parameter values are pre-determined and are separated by a comma in the text message. Usually at least one parameter value is included in the service request message by a user.

Another example of a service is a so-called finder service (again having a certain destination number to which messages for the finder service can be sent). To request the finder service, a message is sent including for example “find” at the beginning of the message. The finder service finds contact information according to specified parameter values. One parameter can be the name parameter. If a user includes in a finder service request a value for the name parameter, the service finds the contact information, e.g. phone number, address, cellular number and mail address, based on the specified name. The user then receives a text message including the contact information associated with the name. If the user sends instead the value for one or more other parameters, e.g. an address or a phone number, the user will receive all available contact information resulting from a search using the other parameters.

The prior art includes some techniques for sending a request for a service without actually having to key in a service identifier number. For example, it is possible to use techniques such as a contact list or an on-phone data store to store data relating to services. Another possibility is simply to resend an earlier request for a service.

Inputting identifiers, parameter values, phone numbers and other such information can be difficult and inconvenient due to the amount, form and possibly order of data to be remembered and input. In some circumstances, even assuming that the subscriber can remember the service identifier number and any parameter values, inputting information typically to a small mobile device is often a time-consuming and error-prone undertaking.

### DISCLOSURE OF THE INVENTION

The object of the invention is thus to provide an enhanced way for sending a service request to a content provider over a communication network, via e.g. a messaging service system or other router or element of the communication network.

Accordingly, a first aspect of the invention is a method for providing a shortcut access to services available via a communication network by a user using a communication device, the method comprising the steps of: displaying a list of one or more selectable services offered by a content provider, wherein said services are accessible by a user of the communication network; and creating an executable shortcut to a service selected by the user from the list of selectable services, for enabling the user to access the selected service.

In accord with the first of the invention, the shortcut may create a message requesting the selected service, and the message may be formed according to a protocol used by a message center of the communication network.

Also in accord with the first aspect of the invention, in providing a shortcut, executable code for a user interface application may be created.

Also in accord with the first aspect of the invention, in providing a shortcut, a configuration file may be created for use in configuring executable code for a user interface application to correspond to the selected service.

Also in accord with the first aspect of the invention, the method may further comprise a step of receiving an indication of a value of a parameter for the selected service, and creating an executable shortcut for enabling automatic access to the selected service with the indicated value for the parameter.

Also in accord with the first aspect of the invention, the executable shortcut may be transferred to the communication device. For example, the executable shortcut may be made available for downloading (e.g. after uploading to a location on a server so as to be downloadable from the location) to the communication device, or may be pushed onto the communication device.

Also in accord with the first aspect of the invention, the executable shortcut may be storable to an element of the communication network in a form downloadable to the communication device via the communication system.

In a second aspect of the invention, a computer program product is provided comprising: a computer readable storage structure embodying computer program code thereon for execution by a processor, the computer program product including instructions for performing the steps of a method according to the first aspect of the invention.

In a third aspect of the invention, a server is provided comprising means for performing a method according to the first aspect of the invention.

In a fourth aspect of the invention, a method is provided for accessing services available via a communication network by a user using the communication device, comprising: displaying an executable shortcut to a service of a content provider via the communication network through the communication network; and sending a request for the service via the message center to the content provider in response to a command by the user for executing the executable shortcut; wherein the executable shortcut is created by a web server in response to user selection of the service, and downloaded to the communication device.

In accord with the fourth aspect of the invention, the method may further comprise: a step of including a value for a parameter for the service in the request for the service.

Also in accord with the fourth aspect of the invention, the method may further comprise a step of enabling the user to input or otherwise indicate a value for a parameter for the service before sending the service request, and a step of including the value for the parameter in the service request.

In a fifth aspect of the invention, a computer program product is provided comprising a computer readable storage structure embodying computer program code thereon for execution by a processor, the computer program product including instructions for performing the steps of a method according to the fourth aspect of the invention.

In a sixth aspect of the invention, a communication device is provided comprising means for performing a method according to the fourth aspect of the invention.

The invention practically eliminates the likelihood of making an error when requesting a service because the user in effect “points and shoots” at the service the user would like to request, by virtue of the user interface application or configuration file provided according to the invention, and the invention thus makes it easy enough to request services of interest to a user that more widespread use of such services is encouraged.

### BRIEF DESCRIPTION OF THE DRAWINGS

For a better understanding of the nature and objects of the present invention, reference is made to the following detailed description taken in conjunction with the following drawings, in which:

FIG. 1 is a block diagram showing an operator network including a web server according to the invention, and also including a messaging system server providing messaging services.

FIG. 2 is a flow chart illustrating a method according to the invention by which the web server of FIG. 1 provides a user interface application (or only a configuration file for use by a user interface application) by which a user can request a messaging service from the messaging system server of FIG. 1.

### DETAILED DESCRIPTION OF THE INVENTION

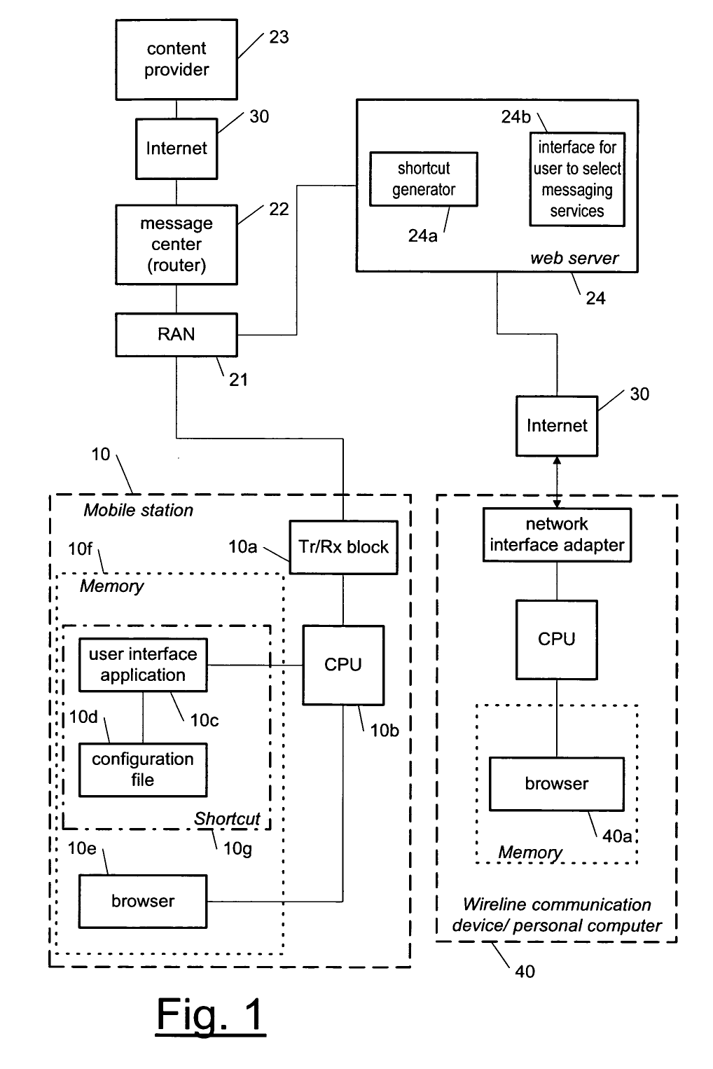

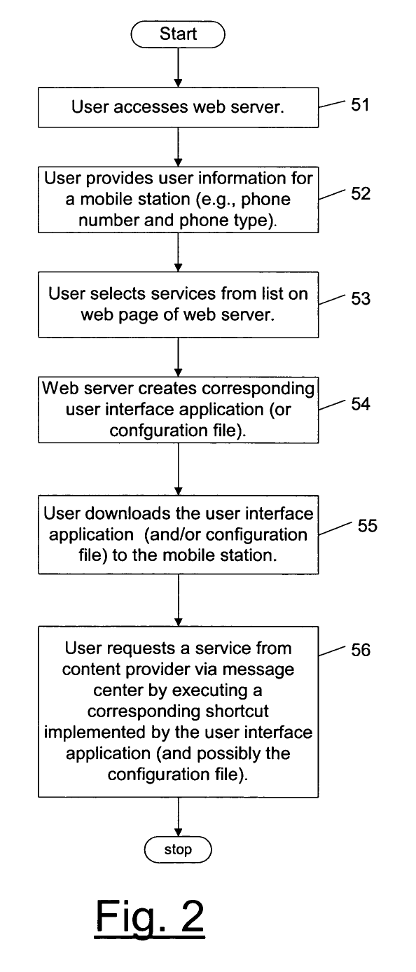

Referring now to FIGS. 1 and 2, the invention provides a method and corresponding equipment and computer program products by which a communication device such as a mobile station 10 (or other communication device) can request a service from a content provider 23 (e.g. a provider of weather reports or a provider of a finder service). The message center 22 is typically an element of a core network of a cellular communication system, and is typically connected to a radio access network (RAN) 21 by other elements (not shown) of the core network. The message center 22 is typically connected to the content provider 23 by a gateway (not shown) via the Internet. The content provider, like the mobile station, is an external smart message entity.

The invention encompasses other kinds of communication devices besides mobile stations (i.e. even other user equipment for use with a cellular communication system), and other kinds of communication networks besides cellular communications networks. For example, the communication network could be a wireless local area network (perhaps communicatively coupled to a cellular communication network), and the communication device could be any kind of communication device able to communicatively couple to the communication network.

According to a typical embodiment of the invention, in a first step 51 the user accesses a web server 24 using a URL. The web server entity 24 can be run by the same network operator that operates the message center 22, or any other individual. The web server is responsible for hosting (one or more) web pages that display a list of services (content) available typically via SMS or MMS and that are of possible interest to a user. The user can access these web pages using network protocols such as WAP, iMode, HTTP, etc. A user could access the web server 24 via a wireline or wireless communication device 40 (such as a personal computer) or mobile station 10 over the Internet 30, using a browser application 40a or 10e. More specifically, when a user accesses the web server, the user interfaces with the web page (or web pages) of the web server, providing an interface 24b by which the user is able to select services of interest to the user, and possibly also indicate values for parameters of the services. In a next step 52, the user provides information about the user's mobile station 10, such as the cell phone number and a model number for the mobile station. In a next step 53, the user selects from the web page the services of interest to the user, and might also select or otherwise indicate values for parameters for the selected services. In a next step 54, the web server creates a user interface application specially tailored to the selections and parameter values indicated by the user, using a shortcut generator module 24a for creating user interface application code or executable application, and provides the user interface application code (or configuration file or both) so as to be transferable to the mobile station 10 (by either steps taken by a user, or without any such steps, as explained below). In creating the user interface application, the shortcut generator module 24a can generate code dynamically, or can assemble previously generated code corresponding to each individual selection by the user. The user interface application 10c can be an executable script like Perl script, bytecode like Java, a native application like native Symbian application, or an application in any other executable form. The invention also encompasses embodiments in which the shortcut generator module 24a creates merely a configuration file for use by a more or less standard user interface application; the configuration file is used as data by the standard user interface application, which is possibly provided with the mobile station 10 at the point of sale or possibly by the original equipment manufacturer, or can even be provided by the web server. In an embodiment in which a configuration file is used, the user interface presented to the user for indicating a request for a service (content) then differs depending on the configuration file.

Note that the executable shortcut is provided as an downloadable (or at any rate, a file that can be transferred) addition to the user interface already resident on the mobile station (or other communication device). The invention encompasses storing the shortcut in an element of the (e.g. cellular) communication network so as to be downloadable by the mobile station.

In a next step 55, the user interface application and/or configuration file is downloaded to the mobile station 10, using a wide variety of methods including possibly accessing the web server 20b using a browser application 10e and wireless access protocol. The downloading and installation of the user interface application 10c and/or configuration file 10d are advantageously performed according to OMA (Open Mobile Alliance) DM (Device Management) and CP (configuration provisioning) specifications. Also, as an alternative, the web server 24 can “push” the user interface application (and/or configuration file) it creates to the mobile device 10, i.e. the user can receive the user interface application (and/or configuration file) on the mobile device 10 without having to issue a download request. Thus, the web server 24 makes the user interface application and/or configuration file available for downloading, or, in the alternative, pushes it to the mobile station 10, where it is then stored in the memory 10f and, if necessary depending on the operating system (not shown) of the mobile station 10, integrated into the mobile station so as to be callable by the operating system.

Thus, the mobile station 10 includes in a memory device 10f the user interface application 10c and possibly also the configuration file 10d. The user interface application 10c and possibly also the configuration file 10d provide/implement what are here called and indicated as executable shortcuts 10g to respective services available via the message center. The shortcuts 10g are executable in that the user “points and shoots,” i.e. selects and executes by e.g. pressing a key on the keypad predetermined to cause a message bearing a request associated with the shortcut to be sent to the content provider via the message center.

In a next step 56, the user sends a request for a service from the content provider 23 via the message center 22, using the shortcut 10g (implemented by the user interface application 10c and possibly the configuration file 10d) to indicate the service being requested, along with corresponding parameter values. The shortcut is executed by a CPU 10b (central processing unit) of the mobile station 10 (and the execution involves reading the configuration file 10d if such is used). When the user has indicated the request to be sent, the shortcut 10g cooperates with functionality (not shown) of the mobile station 10 in order to transmit the request via a TRX (transceiver) 10a to the RAN 21, from where it is communicated to the message center 22, which then relays (or routes) the request to the (appropriate) content provider 23, which in turn provides the requested service and communicates a corresponding message back to the mobile station 10 via the message center 22.

The shortcut 10g provides icons or other devices by which the user can indicate a request for a messaging service, without having to key in a service identifier and associated parameter values. Typically, the icon (or other device) stands for not merely a request for a service, but also for values for the parameters of the service, although the invention also encompasses a shortcut that asks for parameter values in case of the user not specifying parameter value at the web server 24.

As an example of the use of the invention, consider a user asking for a weather report for the southern part of Finland. With the invention the user simply selects an icon or device indicating a request for the service. The act of selecting the icon or other device provided by the shortcut causes the mobile station 10 to send to the message center 22 a request for the service represented by the shortcut, without the user ever having to enter the service number or “South Finland.” The service center parses the request, determines it should be routed to the content provider 23 (assumed here to be the content provider for the indicated weather report), and so routes the request.

In creating the user interface application (in embodiments where this is done, as opposed to simply creating a configuration file for use by a standard user interface application), the web server 20b might create the user interface application in e.g. the Java language for execution by a Java virtual machine, a Perl script, or as a native application such as a Symbian executable, or some other appropriate form . And as explained, when executed, the shortcut can provide icons, buttons, or other user-selectable graphical representations or shortcut devices for sending to the content provider 23 a request for one or another of the services indicated by the user to be of interest to the user (including typically the content or parameters also required by the request), and so for which the user interface application was specially created, or a standard user interface application was configured via a configuration file.

In indicating which services are of interest to the user, the user could browse what is here called a service description component of the interface 24b provided on the web page on the web server 24. The service description component could display a list of service descriptions arranged in categories, to make it easier for the user to find messaging services of interest to the user. The categories could include e.g. subway tickets and weather reports. Under the category weather reports, more specific services could be indicated, to the point that the parameters of a request are ultimately indicated. For example, under weather reports, a service entitled “weather report for South Finland” could be indicated. The designation “South Finland” is a parameter value for a general weather report request, and thus, the user is able to indicate not only a service but also values for parameters for the service simply by selecting from a list of services with indicated values for parameters required by the services. The invention though, also encompasses a user selecting a service and leaving open the values of the parameters, and so providing such values at the time of making a request for the service.

It should be clear from the above description that the invention is of use not only in case of content being provided via a message center, i.e. according to e.g. the SMS or MMS protocol and via a corresponding message center, but also in case of content being provided via any router or server including routing or relay functionality according to one or another protocol.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for providing a shortcut access to services available via a communication network by a user using a communication device, the method comprising the steps of:
displaying a list of one or more selectable services offered by a content provider, wherein said services are accessible by a user of the communication network; and
creating an executable shortcut to a service selected by the user from the list of selectable services, for enabling the user to access the selected service.

2. A method as in claim 1, wherein the shortcut creates a message requesting the selected service, and the message is formed according to a protocol used by a message center of the communication network.

3. A method as in claim 1, wherein in providing a shortcut, executable code for a user interface application is created.

4. A method as in claim 1, wherein in providing a shortcut, a configuration file is created for use in configuring executable code for a user interface application to correspond to the selected service.

5. A method as in claim 1, further comprising a step of receiving an indication of a value of a parameter for the selected service, and creating an executable shortcut for enabling automatic access to the selected service with the indicated value for the parameter.

6. A method as in claim 1, wherein the executable shortcut is transferred to the communication device.

7. A method as in claim 1, wherein the executable shortcut is storable to an element of the communication network in a form downloadable to the communication device via the communication system.

8. A computer program product comprising: a computer readable storage structure embodying computer program code thereon for execution by a processor, the computer program product including instructions for performing the steps of the method of claim 1.

9. A server, for providing a shortcut access to services available via a communication network by a user using a communication device, the server comprising:
means for displaying a list of one or more selectable services offered by a content provider, wherein said services are accessible by a user of the communication network; and
means for creating an executable shortcut to a service selected by the user from the list of selectable services, for enabling the user to access the selected service through the network using the communication device.

10. A server as in claim 9, wherein the shortcut creates a message requesting the selected service, and the message is formed according to a protocol used by a message center of the communication network.

11. A server as in claim 9, wherein in providing a shortcut, executable code for a user interface application is created.

12. A server as in claim 9, wherein in providing a shortcut, a configuration file is created for use in configuring executable code for a user interface application to correspond to the selected service.

13. A server as in claim 9, further comprising a step of receiving an indication of a value of a parameter for the selected service, and creating an executable shortcut for enabling automatic access to the selected service with the indicated value for the parameter.

14. A server as in claim 9, wherein the executable shortcut is transferred to the communication device.

15. A server as in claim 9, wherein the executable shortcut is storable to an element of the communication network in a form downloadable to the communication device via the communication system.

16. A method for accessing services available via a communication network by a user using the communication device, comprising:
displaying an executable shortcut to a service of a content provider via the communication network through the communication network; and
sending a request for the service via the message center to the content provider in response to a command by the user for executing the executable shortcut;
wherein the executable shortcut is created by a web server in response to user selection of the service, and downloaded to the communication device.

17. A method as in claim 16, further comprising: a step of including a value for a parameter for the service in the request for the service.

18. A method as in claim 16, further comprising: a step of enabling the user to input or otherwise indicate a value for a parameter for the service before sending the service request, and a step of including the value for the parameter in the service request.

19. A computer program product providing a computer readable storage structure embodying computer program code thereon for execution by a processor, the computer program product including instructions for performing the steps of the method of claim 16.

20. A communication device for accessing services available via a communication network by a user using the communication device, comprising:
means for displaying an executable shortcut to a service of a content provider via the communication network through the communication network; and
means for sending a request for the service to the content provider in response to a command by the user for executing the executable shortcut;
wherein the executable shortcut is created by a web server in response to user selection of the service, and downloaded to the communication device.

21. A communication device as in claim 20, further comprising: means for including a value for a parameter for the service in the request for the service.

22. A communication device as in claim 20, further comprising: means for enabling the user to input or otherwise indicate a value for a parameter for the service before sending the service request, and means for including the value for the parameter in the service request.
